(19) United States
(12) Patent Application Publication
(10) Pub. No.: US 2009/0297347 A1
(43) Pub. Date: Dec. 3, 2009

(54) Turbine

(76) Inventors: James D. Burr, Lakewood, CO (US); Milton Burr, Aitkin, MN (US)

Correspondence Address: KOLISCH HARTWELL, P.C., 200 PACIFIC BUILDING, 520 SW YAMHILL STREET, PORTLAND, OR, 97204, US

(21) Appl. No.: 12/154,967

(22) Filed: May 27, 2008

(51) Int. Cl. F03B 3/14; F03D 3/06; F03D 11/00

(52) U.S. Cl. 416/98; 416/147

(57) ABSTRACT

A fluid-driven turbine for power generation is provided with a central rotatable shaft and a plurality of vanes mounted on the central shaft and configured to provide a net torque to the shaft when the turbine is disposed in a moving fluid. The vanes may be rotatable around an axis substantially transverse to the central shaft, to provide a relatively large resistive area when moving with the current, and a relatively small resistive area when moving against the current. In this manner, the vanes provide a continuous net torque to the turbine when it is placed in a moving current of fluid.

### TECHNICAL FIELD

The present invention relates generally to electric power generation, and more particularly to a turbine configured to convert the bulk motions of wind, water, or other moving fluids into electricity. Although the invention has wide utility for wind and hydroelectric power generation, it may be particularly suitable for use in rivers and other bodies of water having relatively stable water currents.

### BACKGROUND OF THE INVENTION

Electric power may be generated by a number of methods, including burning fossil fuels such as coal, petroleum or natural gas, through the nuclear decay of heavy elements, from solar energy, from wind energy, and from the energy of moving water, which is also known as hydroelectric power generation. In each case, the harnessed energy is used to rotate a coil of conducting wire relative to a magnet, which produces an electric current in accordance with well-known principles of electromagnetism.

Although coal burning accounts for around half of the electric power generated in the United States each year, producing energy in this manner is unsustainable due to finite coal resources, and also produces undesirable environmental effects. As a result, other methods of power generation may become increasingly important. In particular, hydroelectric power generation currently accounts for roughly eight to ten percent of the power generated in the United States each year, and worldwide, hydroelectric methods supply roughly one fourth of the world's electricity. In countries such as Norway, Zaire and Brazil, almost all electricity is generated hydroelectrically. Although wind power currently only accounts for around one percent of worldwide power generation, this method may become increasingly important as supplies of finite burnable resources dwindle and environmental concerns mount.

Most conventional hydroelectric power generation involves the use of large power generators placed inside or at the base of dams. This is because the amount of power generated by a conventional hydroelectric generating station is roughly proportional to the distance, or “head,” between the upper water level and the turbine driven by the falling water. However, the use of dams affects those who live both upstream and downstream from the dam, and also may drastically modify the local habitats of plants and animals. For example, many large dams in the Columbia River Basin impede the migration of Pacific salmon, which may be leading to the extinction or near-extinction of some species. For this and other reasons, generation of hydroelectric power by methods that do not require dams or reservoirs is desirable.

In addition, most conventional wind generation devices use horizontal axis turbines, in which the turbine blades are oriented into the wind and spin approximately vertically. While this has the advantage that the blades are always facing the wind and generating torque, it also has several disadvantages, including the need for separate wind direction sensing equipment, the complication of rotating the turbine into the wind as the wind changes directions, the creation of vertically directed turbulence that may harm birds and other wildlife, and a large vertical profile that may be more dangerous to flying creatures and aesthetically unappealing. Furthermore, the speed at the tips of the blades in a horizontal axis wind turbine typically exceeds the wind speed, which can further endanger bird life and which has given rise to the nickname “bird blender” for these devices.

For these and other reasons, turbines with vertical axes and horizontal blades may be desirable, particularly if they can be constructed so that the force of the fluid provides the turbine with a relatively large net torque.

### SUMMARY OF THE DISCLOSURE

The present disclosure relates to a fluid-driven turbine for power generation. Turbines according to this disclosure are provided with a central shaft that is rotatable about a central axis, and a plurality of vanes or vane assemblies mounted on the central shaft and configured to undergo rotational motion around the central axis of the shaft, to rotate the shaft. The rotating shaft may be attached to a generator, an alternator, a pump, or any other useful device, in much the same way that the rotation of a conventional turbine may be converted into electricity or useful mechanical work.

To provide a net rotational torque, vanes having a component of motion in the direction of a fluid current (i.e., moving with the current) may be configured to present a relatively large resistive surface area to the moving fluid, whereas vanes having a component of motion opposite the direction of the fluid current (i.e., moving against the current) may be configured to present a relatively small resistive surface area to the moving fluid. Pairs of vanes or vane assemblies located on opposite sides of the central shaft may be configured to open and close in coordinated motion, to present the appropriate surface area to the current on each side of the central shaft in a synchronized manner.

### BRIEF DESCRIPTION OF THE DRAWINGS

FIG. 1 is a side view of an exemplary turbine according to aspects of the present disclosure.

FIG. 2 is a top view of the turbine of FIG. 1, illustrating the operation of the turbine in a fluid current.

FIGS. 3A-D depict the turbine of FIGS. 1 and 2 at various stages of rotation in a fluid current.

FIG. 4 is a magnified view of a portion of the turbine of FIG. 1, showing details of a rotation translation mechanism that coordinates the rotation of vanes disposed on adjacent vane assemblies

FIG. 5 is a magnified side view of an alternative embodiment of a rotation translation mechanism for a turbine, according to aspects of the present disclosure.

FIG. 6 shows an alternative turbine according to aspects of the present disclosure.

### DETAILED DESCRIPTION

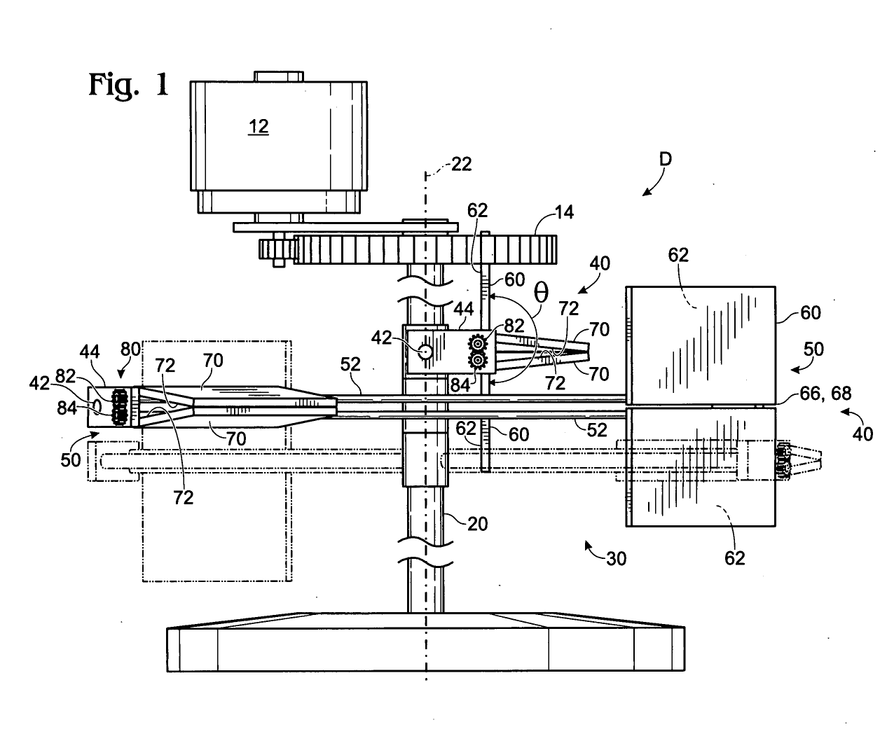

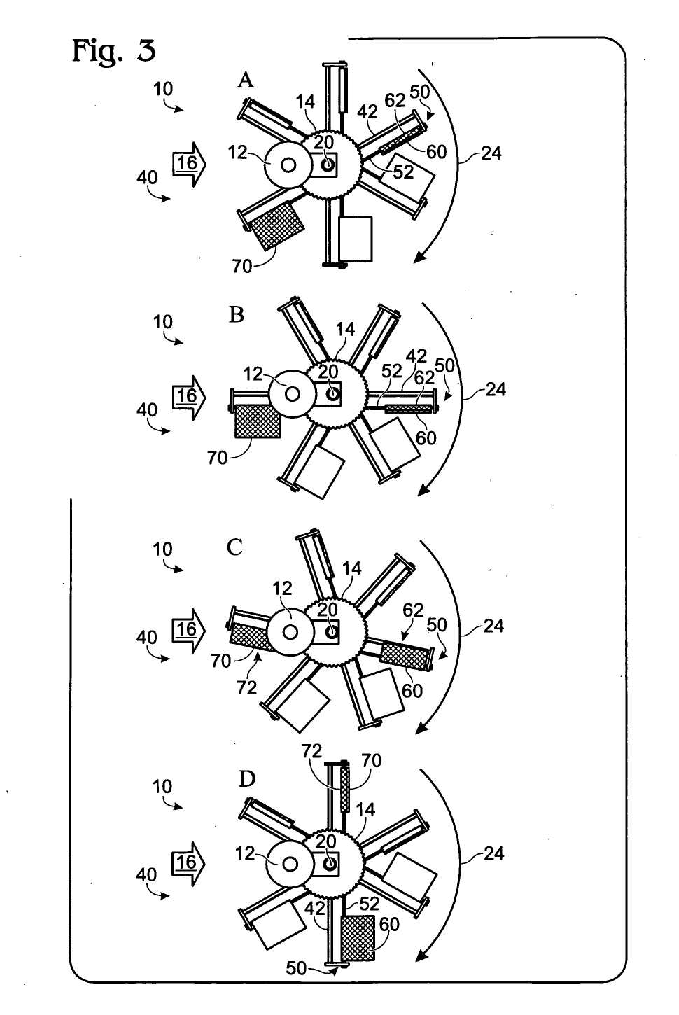

Referring to the embodiment shown in FIG. 1, a turbine 10 is shown comprising a central shaft 20 configured to rotate about a central axis 22 in a preferred direction 24 (see also FIGS. 3A-D). Turbine 10 may include a plurality 30 of vane assemblies mounted on central shaft 20 and arranged in adjacent pairs 40 of vane assemblies. While only two adjacent pairs 40 of vane assemblies are depicted in FIG. 1, it should be understood that other numbers of adjacent pairs 40 of vane assemblies may be included, as demonstrated by the phantom adjacent pair 40 of vane assemblies shown in FIG. 1.

Turbine 10 is shown connected to an ancillary generator 12 via a gear 14. However, the present disclosure is not to be limited to the connection of turbine 10 to this particular device. Connections to other devices and/or mechanisms configured to receive rotational motion, such as, for example, an alternator or a pump, are also within the scope of this disclosure.

Each individual vane assembly 50 of each adjacent pair 40 of vane assemblies may include a support rod 52 rotatable about an axis transverse to central axis 22, and a first vane 60 having a capture surface 62 and being fixedly attached to support rod 52 so that rotation of first vane 60 about axis 22 causes support rod 52 to correspondingly rotate about axis 22, and vice versa.

Each vane assembly 50 also may include a second vane 70 having a capture surface 72 and being fixedly attached to support rod 52 diametrically opposite central shaft 20 from first vane 60 so that rotation of second vane 70 about axis 22 causes support rod 52 to correspondingly rotate about axis 22, and vice versa.

In some embodiments, second vane 70 may be mounted on support rod 52 transversely or even perpendicularly relative to first vane 60, as will be discussed further below. Although for each vane assembly 50, first vane 60 and second vane 70 are separately labeled, first vane 60 and second vane 70 may be identical (although this is not required). Accordingly, the more general reference of “vanes (60, 70)” occasionally will be used below to refer generally to first vanes 60 and second vanes 70.

Each adjacent pair 40 of vane assemblies may be mounted on central shaft 20 in various ways. In some embodiments, each adjacent pair 40 of vane assemblies may include a mounting rod 42 fixedly attached to central shaft 20, the mounting rod 42 supporting the support rods 52 and allowing them to rotate about axis 22. Each adjacent pair 40 of vane assemblies may additionally or alternatively include one or more connecting portions 44 for supporting the two support rods 52 together and/or with mounting rod 42.

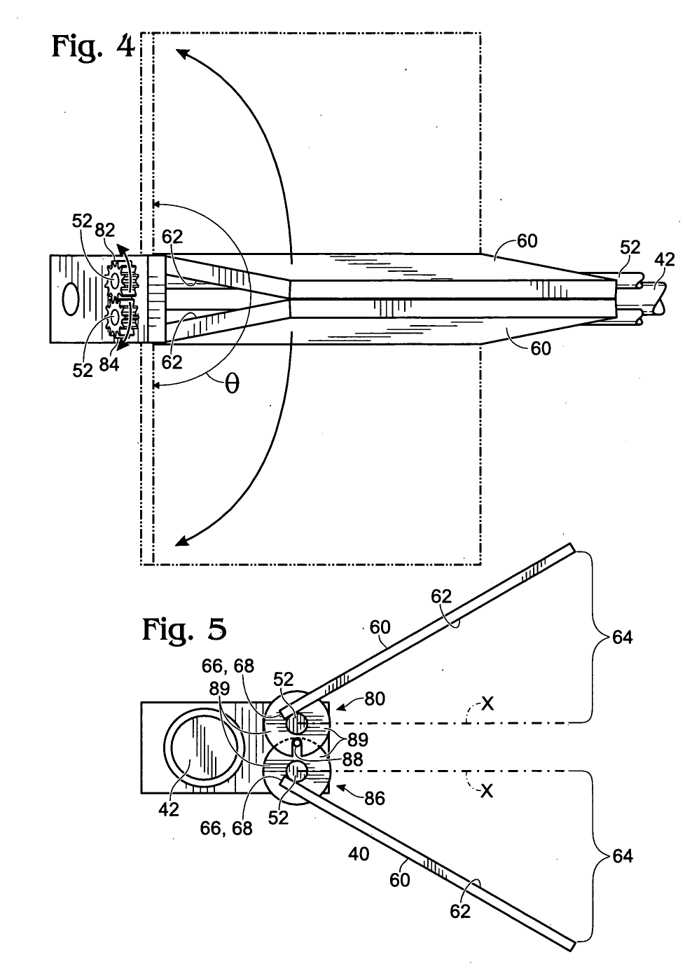

Each vane (60, 70) may be rotated relative to the axis of its respective support rod (see FIG. 4) to define a resistance area 64 (see FIG. 5) proportional to the vertical distance from a distal tip of the vane to an axis X (see FIG. 5) perpendicular both to first axis 22 of central shaft 20 and the axis about which support rod 52 rotates.

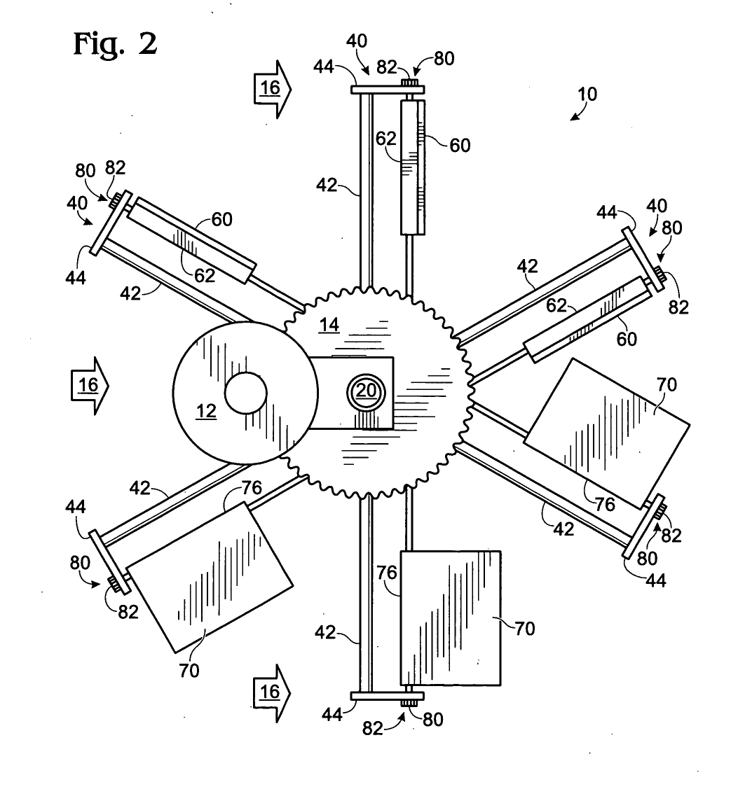

When turbine 10 is submerged in a fluid current 16 (see FIGS. 2 and 3), fluid current 16 asserts a force on capture areas (62, 72) of vanes (60, 70) proportional to resistance area 64. This force may cause vanes (60, 70) to rotate about axis 22, which in turn causes support rods 52 to correspondingly rotate about axis 22. As fluid current 16 asserts force on capture surfaces (62, 72) of vanes (60, 70), torque is produced on central shaft 20, causing it to rotate about first axis 22 in direction 24. It is this rotation that may be harnessed to generate electricity.

In some embodiments, such as the one shown in FIGS. 1-5, for each adjacent pair 40 of vane assemblies, first vane 60 on one vane assembly 50 may be adjacent to first vane 60 on the adjacent and similar vane assembly 50. When fluid current 16 pushes against the capture surfaces 62 of the two first vanes 60, the first vanes 60 may rotate away from one another about the axis of their support rod 52, or in other words, open (see the top three vanes in FIG. 2). On the other hand, when fluid current 16 pushes against the surfaces of first vanes 60 opposite the capture surfaces 62, vanes 60 may rotate toward one another, similar to the motion of a book closing. In other words, when vanes 60 have a component of motion parallel to the fluid current, they will open to present a relatively large resistive surface area to the current, whereas when vanes 60 have a component of motion opposite the fluid current, they will close to present a relatively small resistive surface area to the current.

For each adjacent pair 40 of vane assemblies, second vane 70 on one vane assembly 50 may be adjacent to second vane 70 on the other vane assembly 50, so that fluid 16 current causes them to open and close (see the bottom three vanes in FIG. 2), in a manner similar to the relative motions of first vanes 60. Furthermore, as described below in more detail, opening and closing motions of vanes 70 may be linked to opening and closing motions of vanes 60, so that pairs of vanes or vane assemblies located on opposite sides of the central shaft may be configured to open and close in coordinated motion. This results in the vanes presenting the appropriate surface area to the current on each side of the central shaft in a synchronized manner, to ensure a continuous net torque on the central shaft.

More generally, in some embodiments, for each pair 40 of adjacent vane assemblies, capture surface 62 of first vane 60 on a first vane assembly 50 may at least partially face capture surface 62 of first vane 60 on a second vane assembly 50 when the support rod 52 on each vane assembly is in a closed position (i.e., moving against fluid current 16). Likewise, for each adjacent pair 40 of vane assemblies, capture surface 72 of second vane 70 on a first vane assembly 50 may at least partially face capture surface 72 of second vane 70 on a second vane assembly 50 when the support rods 52 on each vane assembly are in a closed position.

Referring now to FIGS. 3A-D, the operation of a single vane assembly 50 during rotation of turbine 10 in first direction 24 will be described. Although not necessary for all embodiments, each adjacent pair 40 of vane assemblies in FIGS. 3A-D includes a rotation translation mechanism 80 configured to ensure that the rotation of one of the support rods 52 in the adjacent pair 40 of vane assemblies causes the support rod 52 in the other of the adjacent pair 40 of vane assemblies to rotate in an opposite direction. Rotation translation mechanism 80 will be described in more detail further below.

In FIG. 3A, turbine 10 is oriented so that first vane 60 is at approximately the 2 o'clock position. First vane 60 is open because it is completing a turn in direction 24 capturing current 16. Diametrically opposite central shaft 20 from first vane 60 is second vane 70. Second vane 70 is shown closed because current 16 is pushing against the surface opposite second vane's capture surface 72 (seen in FIGS. 3C and D). Second vane 70 is completing its turn moving against the current.

The force asserted on capture surface 62 of first vane 60 causes first vane 60 to rotate towards the open position, causing support rod 52 to correspondingly rotate. This rotation of support rod 52 simultaneously rotates second vane 70 toward its closed position. Likewise, the force asserted on the surface opposite capture surface 72 of second vane 70 causes first vane 70 to rotate towards the closed position, causing support rod 52 to correspondingly rotate. This rotation of support rod 52 simultaneously rotates first vane 60 toward its open position. Accordingly, it should be understood that rotation of either first vane 60 or second vane 70 assists in the rotation of the other, and vice versa. Thus, at any given time, pairs of vanes disposed opposite each other relative to the central shaft will be rotationally offset relative to the axes of their respective support rods, typically by an amount near 90 degrees, but in general by any desired amount. This offset ensures that when one vane is open, its counterpart on the other side of the central shaft will be closed, and vice versa.

In FIG. 3B, turbine 10 is at a later stage of rotation where first vane 60 is at approximately the 3 o'clock position. First vane 60 is still open because it is now at a neutral position, and there is not yet any force acting either its capture surface 62 or the surface opposite thereof. Second vane 70 is also at a neutral position because no forces are acting on either the capture surface 72 (see FIG. 3D) or the surface opposite thereof.

In FIG. 3C, turbine 10 is slightly rotated in first direction 24 from its position in FIG. 3B. First vane 60 is just beginning to close because fluid current 16 is beginning to act on the surface of first vane 60 opposite capture surface 62. This force, in conjunction with the force of fluid current 16 beginning to act on capture surface 72 of second vane 70, simultaneously causes second vane 70 to begin to open.

In FIG. 3D, first vane 60 and second vane 70 are closed and open, respectively, which is opposite to their configuration shown in FIG. 3A. Capture surface 72 of second vane is receiving the full force of fluid current 16, pushing it open. The surface of first vane 60 opposite its capture surface 62 likewise is being pushed closed by the full force of fluid current 16. Additionally, the rotation of support rod 52 caused by the rotation of each vane causes the other vane to correspondingly rotate.

While many embodiments will be configured for submersion into liquid currents (e.g., a river) to generate hydroelectric power, it should be understood that other currents created by other moving fluids, such as air, may also be harnessed by embodiments of this disclosure.

In some embodiments, adjacent vanes (60, 70) may open up to a maximum angle, labeled θ in FIGS. 1 and 4. In the embodiments in FIGS. 1 and 4, θ is approximately 180°, thus making resistance area 64 approximately equal to the entire surface area of the defining vane (60, 70). In other embodiments, θ may be less than 180°, causing resistance area 64 to be smaller but possibly resulting in beneficial effects, such as turbulence or edge effects, which may outweigh this reduction in resistance area and result in a greater resistive force than the flat planar surface presented when the angle is 180°.

Vanes (60, 70) may be prevented from opening further than θ by various mechanisms. In some embodiments, seen best in FIG. 5, for each adjacent pair 40 of vane assemblies, each first vane 60 may include a blocking portion or physical stop 66, which may be configured to stop the outward rotation of each vane at any desired position.

More specifically, each first vane 60 may be attached to support rod 52 at a position adjacent to a first edge 68 of first vane 60 so that first edge 68 forms part of blocking portion 66. The blocking portion 66/first edge 68 on first vane 60 on one vane assembly 50 of each adjacent pair 40 of vane assemblies may be configured to abut the blocking portion 66/first edge 68 on first vane 60 on the other vane assembly 50 of each adjacent pair 40 of vane assemblies when first vanes 60 open (i.e., when fluid current 16 pushes against their capture surfaces) to prevent first vanes 60 from opening further than θ. In other words, edges 68 of adjacent vanes 60 may interfere with each other and prevent further motion, once the angle between the vanes reaches a desired maximum. Second vanes 70 may also include similar blocking portions (not shown) as first vanes 60.

As noted above, second vane 70 may be mounted on support rod 52 transversely or even perpendicularly relative to first vane 60. Accordingly, each support rod 52 may be rotatable between a first position where capture surface 62 of first vane 60 defines a first resistance area 64 (see FIG. 4; resistance area 64 may vary depending on the position of the vane but will always be referred to by reference numeral 64) and capture surface 72 of second vane 70 defines a second resistance area 64 less than the first resistance area 64, and a second position where capture surface 62 of first vane 60 defines a third resistance area 64 less than the first resistance area 64 and capture surface 72 of second vane 70 defines a fourth resistance area greater than the third resistance area.

In some embodiments, the second and third resistance areas may be substantially equal. Likewise, in some embodiments, the first and fourth resistance areas may be substantially equal. Equalizing the resistance areas in this manner ensures that the rotation of turbine 10 about first axis 22 remains constant in a constant fluid current 16.

While the vanes (60, 70) are shown generally being substantially planar, it should be understood that the vanes (60, 70) may take other shapes. For example, vanes (60, 70) may have capture surfaces (62, 72) that are at least partially concave.

Support rods 52 may be various lengths. In one embodiment, support rods 52 are at least about three feet in length. Greater lengths are possible, and may only be limited by the space available in fluid current 16 (e.g., depth and width of a river). Because the torque produced by each vane around the central shaft is directly proportional to the length of the corresponding support rod, relatively large turbine assemblies may be desirable.

As mentioned previously, in some embodiments, each adjacent pair 40 of vane assemblies includes a motion translation mechanism 80 configured to ensure that rotation of the support rod 52 on one vane assembly 50 in each adjacent pair 40 of vane assemblies causes the support rod 52 on the other vane assembly 50 in each adjacent pair 40 of vane assemblies to rotate in an opposite direction.

In the embodiments shown in FIGS. 1-4 and 6, rotation translation mechanism 80 comprises a first gear portion 82 on one vane assembly 50 of each pair 40 of vane assemblies, and a second gear portion 84 on the other vane assembly 50 of each pair 40 of vane assemblies. First gear portion 82 and second gear portion 84 may be engaged with each other so that rotation of one support rod 52 in each adjacent pair 40 of vane assemblies causes the other support rod 52 in each adjacent pair 40 of vane assemblies to rotate in an opposite direction.

In an alternative embodiment shown in FIG. 5, each rotation translation mechanism 80 comprises a slotted cam assembly 86 wherein a pin 88 is disposed within two or more slotted cams 89 so that rotation of one slotted cam 89 causes another slotted cam 89 to oppositely rotate. In general, any mechanism that links the rotational motions of the adjacent support rods about their own longitudinal axes may be suitable.

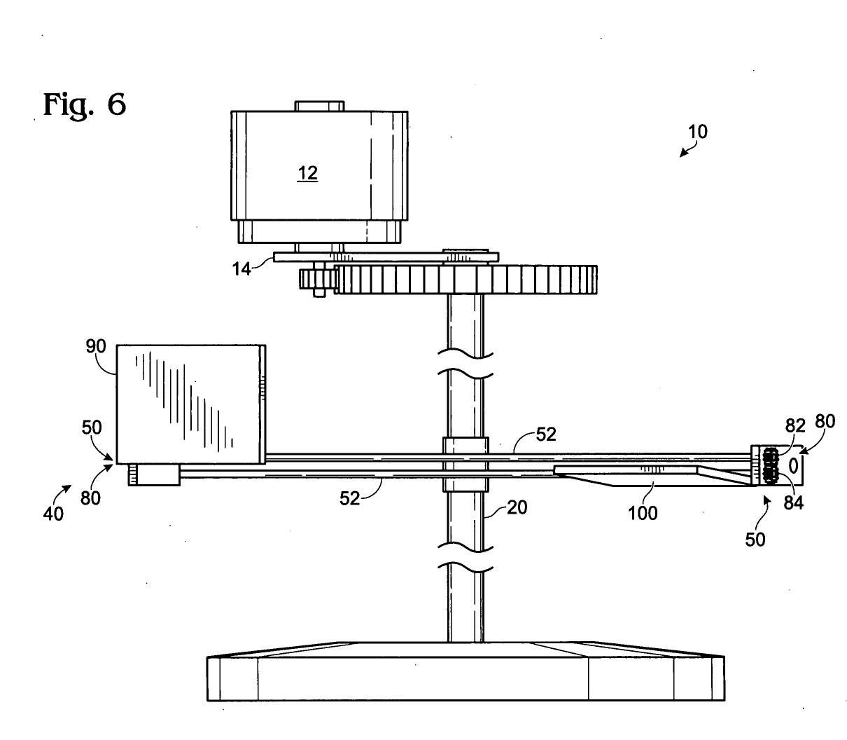

In some embodiments, such as the one shown in FIG. 6, each vane assembly 50 may only include a single vane mounted on support rod 52. In such cases, for each adjacent pair 40 of vane assemblies, a vane 90 on a first vane assembly 50 may be disposed diametrically opposite central shaft 20 from a vane 100 on a second, adjacent vane assembly 50.

In such embodiments, each support rod 52 may be rotatable between two positions. In a first position, for each adjacent pair 40 of vane assemblies, the capture surface of third vane 90 on one of the vane assemblies defines a first resistance area and the capture surface of fourth vane 100 on the other one of the vane assemblies defines a second resistance area smaller than the first resistance area. In a second position, for each adjacent pair 40 of vane assemblies, the capture surface of vane 90 may define a third resistance area and the capture surface of vane 100 may define an fourth resistance area larger than the third resistance area. In other words, both of vanes 90, 100 are capable of moving between a maximally fluid resistive position and a minimally fluid resistive position.

Furthermore, as was the case with previously described embodiments, each adjacent pair 40 of vane assemblies may include a motion translation mechanism 80 similar to that described above, to synchronize the opening and closing motions of vanes located on opposed sides of the central shaft.

While the present description has been provided with reference to the foregoing embodiments, those skilled in the art will understand that many variations may be made therein without departing from the spirit and scope defined in the following claims. The description should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring, nor excluding, two or more such elements.

I claim:

1. A turbine comprising:
a linear central shaft configured to rotate about a first axis;
a plurality of vane assemblies mounted on the central shaft and arranged in adjacent pairs, each adjacent pair including first and second vane assemblies, each vane assembly including:
a support rod rotatable about an axis transverse the first axis;
a first vane having a capture surface and being fixedly attached to the support rod so that rotation of the first vane causes the support rod to correspondingly rotate; and
a second vane having a capture surface and being fixedly attached to the support rod diametrically opposite the central shaft from the first vane so that that rotation of the second vane causes the support rod to correspondingly rotate;
wherein each support rod is rotatable between a first position where the capture surface of the first vane defines a first resistance area and the capture surface of the second vane defines a second resistance area less than the first resistance area, and a second position where the capture surface of the first vane defines a third resistance area less than the first resistance area and the capture surface of the second vane defines a fourth resistance area greater than the third resistance area.

2. The turbine of claim 1 wherein for each pair of vane assemblies, the first vane of the first vane assembly is adjacent to the first vane of the second vane assembly.

3. The turbine of claim 2 wherein for each pair of vane assemblies, the second vane of the first vane assembly is adjacent to the second vane of the second vane assembly.

4. The turbine of claim 1 wherein for each pair of vane assemblies, the capture surface of the first vane on the first vane assembly at least partially faces the capture surface of the first vane on the second vane assembly when the support rods on the first and second vane assemblies are in the second position.

5. The turbine of claim 1 wherein each pair of vane assemblies includes a motion translation mechanism configured to ensure that rotation of the support rod on one of the first or second vane assemblies causes the support rod on the other of the first or second vane assemblies to rotate in an opposite direction.

6. The turbine of claim 5 wherein each rotation translation mechanism comprises a first gear portion on the support rod of the first vane assembly and a second gear portion on the support rod of the second vane assembly, the first and second gear portions being engaged so that rotation of the support rod on one of the first or second vane assemblies causes the support rod on the other of the first or second vane assemblies to rotate in an opposite direction.

7. The turbine of claim 5 wherein each rotation translation mechanism comprises a slotted cam drive connecting the support rod of the first vane assembly to the support rod of the second vane assembly

8. The turbine of claim 1 wherein the first and second vanes are substantially planar.

9. The turbine of claim 1 wherein the capture surfaces on the first and second vanes are concave.

10. The turbine of claim 1 wherein the length of each support rod is at least about three feet.

11. The turbine of claim 3 wherein for each adjacent pair of vane assemblies, each of the first vanes includes a blocking portion, the blocking portions on the first vanes cooperating to prevent the first vane on one of the first or second vane assemblies from rotating its capture surface more than 180 degrees from the capture surface of the first vane of the other of the first or second vane assemblies.

12. The turbine of claim 11 wherein for each vane assembly, the first vane is attached to the support rod at a position adjacent a first edge of the first vane so that the first edge forms part of the blocking portion, and wherein for each adjacent pair of vane assemblies, the blocking portion of the first vane of the first vane assembly is configured to abut the blocking portion of the first vane of the second vane assembly when the support rods of the first and second vane assemblies are in the first position.

13. A turbine comprising:
a linear central shaft configured to rotate about a first axis in a first direction;
a plurality of vane assemblies mounted on the central shaft and arranged in adjacent pairs, each pair including a first vane assembly and a second vane assembly, each vane assembly including:
a support rod mounted on the central shaft so that it is rotatable about an axis transverse the first axis;
a vane having a capture surface and being fixedly attached to the support rod so that rotation of the vane causes the support rod to correspondingly rotate; and
wherein for each adjacent pair of vane assemblies, the vane on the first vane assembly is disposed diametrically opposite the central shaft from the vane on the second vane assembly, and each support rod is rotatable between a first position where the capture surface of the vane on the first vane assembly defines a first resistance area and the capture surface of the vane on the second vane assembly defines a second resistance area smaller than the first resistance area, and a second position where the capture surface of the vane on the first vane assembly defines a third resistance area and the capture surface of the vane on the second vane assembly defines a fourth resistance area larger than the third resistance area; and
wherein each adjacent pair of vane assemblies includes a motion translation mechanism configured to ensure that rotation of the support rod on one of the first or second vane assemblies causes the support rod on the other of the first or second vane assemblies to rotate in an opposite direction.

14. The turbine of claim 13, wherein the second and third resistance areas are substantially equal, and the first and fourth resistance areas are substantially equal.

15. The turbine of claim 13 wherein each rotation translation mechanism comprises a first gear portion on the support rod of the first vane assembly and a second gear portion on the support rod of the second vane assembly, the first and second gear portions being engaged so that rotation of the support rod on one of the first or second vane assemblies causes the support rod on the other of the first or second vane assemblies to rotate in an opposite direction.

16. The turbine of claim 13 wherein each rotation translation mechanism comprises a slotted cam drive connecting the support rod of the first vane assembly to the support rod of the second vane assembly.

17. A turbine comprising:
a central rotatable shaft;
at least one vane assembly mounted on the central shaft, each vane assembly including:
a support rod mounted on the central shaft and rotatable about an axis substantially transverse to the central shaft;
a first vane fixedly attached to the support rod in a first orientation; and
a second vane disposed substantially opposite the first vane relative to the central shaft and fixedly attached to the support rod in a second orientation rotationally offset from the first orientation;
wherein the support rod is rotatable between a first position where the first vane defines a first resistance area and the second vane defines a second fluid resistance area less than the first resistance area, and a second position where the first vane defines a third fluid resistance area less than the first resistance area and the second vane defines a fourth fluid resistance area greater than the third resistance area.

18. The turbine of claim 17, wherein the second orientation is offset from the first orientation by substantially ninety degrees.

19. The turbine of claim 17, wherein the first and second vanes each have a concave surface.

20. The turbine of claim 17, wherein the at least one vane assembly includes two adjacent vane assemblies linked together in synchronized motion by a pair of meshed gears.
